(19) United States
(12) Patent Application Publication
(10) Pub. No.: US 2025/0220468 A1
(43) Pub. Date: Jul. 3, 2025

(54) METHOD FOR MONITORING A QUALITY-OF-SERVICE LEVEL BETWEEN A USER DEVICE AND AN ACCESS DEVICE FOR ACCESSING A COMMUNICATION NETWORK, AND CORRESPONDING APPARATUS, ACCESS DEVICE, COMMUNICATION SYSTEM AND COMPUTER PROGRAM

(71) Applicant: Orange, Issy-Les-Moulineaux (FR)

(72) Inventor: Jean-Marc KELIF, Chatillon Cedex (FR)

(21) Appl. No.: 18/844,265

(22) PCT Filed: Mar. 6, 2023
(86) PCT No.: PCT/EP2023/055553

§ 371 Date: Sep. 5, 2024

(30) Foreign Application Priority Data
Mar. 7, 2022 (FR) FR2201972

(51) Int. Cl. H04W 24/08; H04B 7/185; H04W 28/02

(52) U.S. Cl. CPC H04W 24/08; H04B 7/18539; H04W 28/0268

(57) ABSTRACT

A method for monitoring a quality-of-service level of a communication between a user device and a first wireless communication network, the method including: determining a value of a parameter representative of the quality-of-service level of the communication between a serving device of the first network to which the user device is attached and the user device, to another access device of the first network and to another access device of a second wireless communication network, likely to interfere with the communication, and to a topology of the first network and of the second network in an interference zone; when the determined value does not reach a target value of the parameter, obtaining a modification of a transmission feature of the serving access device and/or another access device of the first and/or of the second network, according to a difference between the determined value and the target value.

### CROSS-REFERENCE TO RELATED APPLICATIONS

This application is filed under 35 U.S.C. § 371 as the U.S. National Phase of Application No. PCT/EP2023/055553 entitled “METHOD FOR MONITORING A QUALITY-OF-SERVICE LEVEL BETWEEN A USER DEVICE AND AN ACCESS DEVICE FOR ACCESSING A COMMUNICATION NETWORK, AND CORRESPONDING APPARATUS, ACCESS DEVICE, COMMUNICATION SYSTEM AND COMPUTER PROGRAM” and filed Mar. 6, 2023, and which claims priority to FR2201972 filed Mar. 7, 2022, each of which is incorporated by reference in its entirety.

### BACKGROUND

### Field

The present development relates to general domain of telecommunications. It relates more specifically to the cohabitation of several wireless communication networks using the same resources in a given geographical zone.

The development has a privileged but non-limiting application in the context of mobile services relying on such communication networks.

### Description of the Related Technology

Today, there are several types of networks enabling a user to access mobile communication services, such as a land cellular network, a satellite network, a network of remotely controlled devices or drones, or a network of High Altitude Platforms (HAP). These different types of networks can be managed by the same operator or by separate operators.

However, frequency spectrum is a rare commodity, and given the growing number of networks and the plurality of operators, we can expect the same frequency band to be allocated to several heterogeneous networks, for example to a land mobile network and a satellite network managed by the same operator (or by separate operators). In this context, the communications established within these networks with user devices located in the same geographical zone and relying on the same resources will create interference with each other, which will have an impact on the quality of these communications, and therefore on the experience of the users of the user devices.

In the current state of the art, it is known to take into account, in the context of a cellular network, for example compliant with the third generation of the 3GPP (3G) standard, intra-cellular and/or inter-cellular interference related to the use of the same resources (and in particular the same frequency band) on a communication of a user.

In a satellite context, the paper by N. Gupta and S. Bitragunta, “Green Satellite Communication Link Design, Optimization and Performance Analysis”, IEEE 7th Uttar Pradesh Section International Conference on Electrical, Electronics and Computer Engineering (UPCON), 2020, pages 1-5, focuses on the performance of a satellite network in terms of energy efficiency, which is defined in terms of thermal noise power. The document mentions the possibility of taking interference into account when calculating this energy efficiency in case of frequency spectrum sharing, but no indication is given as to the nature of the interference in question or how this should be done.

In any case, none of these approaches focuses on the coexistence of several networks of different types (e.g. satellite network, land cellular network, etc.) in the same geographical zone (also referred to as “heterogeneous networks” hereafter) and does enable a network operator to ensure the performance of their network in the event of simultaneous use of the same resources by different access devices belonging to networks of different types.

In particular, none of these approaches enables a network operator to ensure that in such a context they are able to provide a given quality of service to a user device.

The development improves the situation.

### SUMMARY

The development responds to this need by providing a method for monitoring a quality-of-service level of a communication between a user device and a first wireless communication network, said method comprising:
determining a value of a parameter representative of the quality-of-service level of the communication between an access device referred to as serving device of the first network to which said user device is attached and said user device, said communication using a given frequency band, said value being determined at least according to a bandwidth allocated to this communication, to transmission features of the serving device, to at least one other access device of the first network and to at least one other access device of at least one second wireless communication network, said at least one other access device of the first network and said at least one other access device of said at least one second network being configured to use said given frequency band and being likely to interfere with the communication, and to a topology of the first network and of the at least one second network in at least one zone referred to as interference zone;
when the determined value does not reach a target value of said parameter, obtaining a modification of at least one transmission feature of said serving access device and/or of at least one other access device of the first and/or of the at least one second network, according to the target value.

For example, said parameter value is determined at least according to the bandwidth allocated to the communication, to a distance between the user device and the serving device, to a transmission power of the serving device, to antenna gain ratios between the serving device and said at least one other access device of the first network and between the serving device and said at least one other access device of the at least one second network, and to the topology of the first network and of the at least one second network in said at least one interference zone.

The development applies primarily to a communication in the downlink direction, i.e. from the serving device to the user device.

It also applies in a privileged way when the first and second network are distinct and heterogeneous networks in the sense that they rely on different technologies and include access devices of different types. For example, the first network comprises land base stations and the second network of the access devices located in the air or in space, such as satellites. Of course, the development is not limited to this example of a second satellite network and applies to other types of networks, such as a network of drones and a network of high-altitude platforms. For the sake of simplicity, such a network (i.e. relying on access devices located in the air, such as drones or high-altitude platforms, or on access devices located in space, such as satellites) will be referred to hereafter as “aerial” network.

It is also assumed that the user device can be attached to any type of access device, belonging to any of the aforementioned communication networks of the land or aerial type.

No limitation is attached to the nature of the user device. It can be any receiving device, such as a fixed or mobile terminal that is a client of the first network (e.g. a smartphone, a computer, etc.). In the event that the serving device is a satellite of a satellite network, the user device can also be a land radio transmitting/receiving station of this satellite network.

The development is based on a completely new and inventive approach to monitoring a quality-of-service level on the downlink radio link between a user device and the serving access device connecting it to a first communication network in the presence of interference generated by other networks. It consists in determining the actual value of a quality-of-service parameter as perceived at the user device level, taking into account the influence on the performance of the communication not only of the transmission features of the serving device (e.g. transmission power, distance from the user device), those of other interfering access devices of the first network and of at least one second network, but also the topology of each of these networks in an interference zone.

Typically, such a topology can include a density of access devices of the first and of the second networks likely to interfere with the communication in an interference zone, an average distance between the access devices, an altitude of the access devices, a minimum angle of elevation or any other feature enabling an interference zone to be defined with the communication. This topology in the interference zone is used by the development to model in a very simple way the interference generated on the communication between the serving access device and the user device by the other access devices simultaneously using the same resources (and more particularly here the same frequency band) as the serving access device during its communication with the user device. More specifically, the development does not involve determining in a tedious way the individual contribution of each access device interfering with the communication, then summing up the individual contributions of these access devices, but considers the impact of these other access devices on the communication as a whole thanks to knowledge of the topology of the networks to which they belong.

When the actual value obtained does not reach a given target value, for example required by an application running on the user device, a modification to be made to the value of one or more transmission features of one or more access devices of the first network and/or the second network is determined so as to reach this target value.

The development therefore makes it possible to configure the serving device of the user device and/or one or more access devices of one or more networks of different types which interfere with the communication between the serving device and the user device to enable it to reach the target value. The modification of the at least one transmission feature can therefore be applied to the serving access device and/or to other access devices of the first network and/or to access devices of the second network.

Thus, the development can be used upstream of a communication: it then enables the operator of the first network to know whether a serving access device likely meets a quality of service requested by a user device. If it is not possible to determine a modification of the transmission features of the serving access device verifying this quality of service, the operator can advantageously anticipate a failure of the communication and consider various actions upstream of the communication aimed at improving the user experience: informing the user, rejecting the communication, selecting another access device to serve the communication, etc. Alternatively, it can also modify the transmission features of other interfering access devices of the first network or those of interfering access devices of the second network, particularly if it is itself the operator. If the second network is operated by another operator, inter-operator agreements can be set up for this purpose.

However, the development can also be used during communication to adapt the values of one or more transmission features of this communication dynamically, such as the transmission power of the serving access device, the bandwidth allocated to the communication or the communication rate.

The development can also be implemented in a tool for planning the deployment of land or aerial access devices (including drones, high-altitude platforms and/or satellites).

According to one aspect of the development, the first network and the second network are networks of distinct types belonging to a group comprising at least one network of the land type comprising a plurality of land base stations and a network referred to as of the aerial type comprising a plurality of aerial or space access devices, and determining a value of a parameter representative of the quality-of-service level of the communication comprises determining a first impact factor on the value of said parameter of the other access devices of the first network interfering with the communication and determining a second impact factor on the value of said parameter of the access devices of the second network interfering with the communication.

“Network of the aerial type” designates both a satellite communication network where the access devices are a satellite, for example satellites placed in orbit around the Earth at around 600 km from the ground, and a communication network using drones located a few hundred metres from the ground or a communication network using high-altitude platforms located at around 80 km from the ground.

According to the development, the serving device can therefore be a land base station, a satellite, a drone, a high-altitude platform, etc.

One advantage of the development is that it enables determining globally on one hand the impact of the other access devices of the first network and on the other hand the impact of the access devices of the second network on the communication between the serving device and the user device.

According to another aspect of the development, the first network being a network of the land type and the serving device being a land base station, determining the first impact factor, referred to as land impact factor, depends on a density of other land base stations of the first network, referred to as interfering base stations, located in a land interference zone defined at least according to an average distance between the base stations of the first network. The development thus proposes to define a land interference zone according to the topology of the first network and to determine the overall impact of the other interfering land base stations on the quality of service of the downlink radio link between the serving base station rather than adding up the individual impacts of each of them. One advantage is that it is not necessary to know the absolute positions of each of the other base stations in relation to the user device. The technique of the development is therefore relatively uncomplicated.

According to yet another aspect of the development, the serving base station comprising a first, a second and a third antennas covering three sectors, determining the land impact factor Fb comprises the implementation of a relation equivalent to the following relation:

$$Fb ( ISD , h , r , θ , φ ) = \frac{{ρ}_{B} {{V}_{1} ( ISD - r )}^{2 - δ} {\int }_{0}^{2 π} {H}_{1} ( θ ) d θ}{( δ - 2 ) {( {r}^{2} + {h}^{2} )}^{- \frac{δ}{2}} A ( θ , φ )} + {\sum }_{2}^{3} \frac{A ( {θ}_{k} , {φ}_{k} )}{A ( θ , φ )} ,$$

where ISD is the average distance between the serving base station and the interfering base stations,
β_{B} is the density of base stations in the land interference zone,
δ is the path-loss factor modelling propagation attenuation,
r is the radius or distance between the user device and the first antenna,
h is the height of the first antenna relative to the user device,
(r, θ, φ) refers to the spherical coordinates of the user device in an O1′xyz coordinate system centred on the serving base station at ground level,
θ is the angle of elevation between the user device and said first antenna,
ϕ is the horizontal angle between the user device and said first antenna,
A(θ, φ) is the angular gain of the first antenna of the serving base station, to which the user device UE is connected;
A(θₖ, φₖ) the angular gain of each of the two other antennas (k=2, 3) of the serving base station, co-located with the first antenna of the serving base station.
H1 is the gain of each antenna of the first network RT, defined as follows by: H₁(θ)_{dB}=−min [−H(θ)_{dB}, Aₘ+V_{1,dB}], where Am is the minimum antenna gain, and

$${V}_{1 , dB} = - min [ 12 {( \frac{{φ}_{tilt}}{{φ}_{3 dB}} )}^{2} , {A}_{m} ] , with {H ( θ )}_{dB} = - min [ 12 {( \frac{θ}{{θ}_{3 dB}} )}^{2} , {A}_{m} ]$$

is a constant,

$${V ( φ )}_{dB} = - min [ 12 {( \frac{φ - {φ}_{tilt}}{{φ}_{3 dB}} )}^{2} , {A}_{m} ]$$

where φₜᵢₗₜ is the downward tilt angle, φ_{3dB} the vertical beamwidth at half-power, θ_{3dB} the horizontal beamwidth at half-power, and a contribution from the other two antennas of the serving base station uses a relation equivalent to the following:

$${\sum }_{2}^{3} \frac{A ( {θ}_{k} , {φ}_{k} )}{A ( θ , φ )} = \frac{( {θ}_{2} , {φ}_{2} ) + ( {θ}_{3} , {φ}_{3} )}{A ( θ , φ )}$$

where k=2,3 the other two antennas of the base station.

According to another aspect of the development, the second network being a network of the aerial type comprising a plurality of satellites placed in orbit around the Earth, determining the second impact factor, referred to as satellite impact factor, depends on a density of satellites interfering with the communication in a satellite interference zone defined at least according to an altitude of the satellites of the second network and a minimum angle of elevation of a said satellite with said user device.

According to this embodiment, the development relies on the fact that the satellites present in the satellite interference zone cover a geographical zone intersecting all or part of the geographical coverage zone of the serving device (in which the user device is located) and are therefore likely to generate overall interference at the user device level which depends on the density of the satellites using the same resources as the serving access device in this zone.

It should be noted that to maximise the quality-of-service level in the second (satellite) network, and in particular the rate offered by this network, it is necessary to maximise the use of resources: as a result, the satellites use all their resources. In such a configuration, all the satellites in the satellite interference zone are likely to interfere with the communication between the serving access device and the user device, as the probability of these satellites simultaneously using the same resources as the communication tends towards 1. The density of satellites likely to interfere with the communication located in the satellite interference zone is therefore equal or substantially equal to the density of satellites of the system located in the satellite interference zone. If, however, the assumption that all the resources are used by the satellites in the satellite network does not apply, it is necessary to consider the density of the satellites located in the satellite interference zone and that are simultaneously using the same resources as the communication in question.

According to this embodiment, the impact factor of the satellites of the second network on the communication is defined as the product of the density of the satellites and the integral of the power received by the user device from the satellites of the second network likely to interfere with the communication located in the satellite interference zone. According to another embodiment, other types of aerial access devices, for example drones, are present near the user device (in addition to the aforementioned satellites or as a replacement), use the same frequency band and are therefore likely to interfere with the communication between the user device and the serving device of the first network. Advantageously, determining a value of a parameter representative of the quality-of-service level of the communication then also takes into account a transmission power and antenna gain ratios of drones of this third network and comprises determining a third impact factor (Fd), referred to as the drone impact factor, said drone impact factor depending on a density of interfering drones in an drone interference zone. A similar reasoning can be applied to aerial access devices of the HPA type with determining an HPA impact factor.

According to yet another aspect of the development, when the second network is a satellite network, determining a value of a quality-of-service parameter further comprises determining a number of interfering satellites for said communication in the satellite interference zone and the density of interfering satellites in the satellite interference zone is determined according to the number of interfering satellites and to an area of a spherical cap centred on the user device, the radius of which being the orbit of the satellites of the satellite network, and bounded by taking said minimum angle of elevation into account.

In a particular embodiment of the development, determining the satellite impact factor involves implementing a relation equivalent to the following equation:

$${F}_{SAT} = {ρ}_{SAT} \frac{π * {( {R}_{T} + {h}_{SAT} )}^{2}}{( {R}_{T} * ( {R}_{T} + {h}_{SAT} ) )} Log \frac{A}{B}$$

Where.
β_{SAT} is the density of interfering satellites (i.e. in the satellite interference zone),
R_{T} is the radius of the Earth,
h_{SAT} the altitude of interfering satellites in a coordinate system centred on the user device,

$$A = {( {R}_{T} + {h}_{sSAT} )}^{2} + {{R}_{tT}}^{2} - \frac{2 {R}_{T} ( {R}_{T .} + {h}_{SAT} ) ( {R}_{T .} + {d}_{M} sin ∝ )}{( {R}_{T .} + {h}_{SAT} )} ,$$

$$B = {( {R}_{T} + {h}_{sSAT} )}^{2} + {{R}_{tT}}^{2} - 2 {R}_{T} ( {R}_{T .} + {h}_{SAT} ) ,$$

∝ is the minimum angle of elevation and dM is the distance between the user device and a satellite located at the minimum angle of elevation.

One advantage is that, via geometric considerations, the development makes it possible, from this integration on the satellite interference zone, defined as a spherical cap centred on the user device, the radius of which being the orbit of the satellites in the satellite network, and bounded by taking into account a minimum angle of elevation of the satellites to be likely to interfere with the communication, to obtain a very simple expression of the satellite impact factor.

According to another aspect of the development, the determination of a value of a parameter representative of the quality-of-service level of the communication further comprises determining a transmission power by the serving base station according to the land impact factor and to the at least one second impact factor associated with said at least one second network, implementing a relation equivalent to the following relation:

$${P}_{b} = \frac{{\sum }_{i = 2}^{I} {G}_{i} {P}_{i} {K}_{i} {F}_{i} + {N}_{th}}{{GbKb ( {r}^{2} + {h}^{2} )}^{- \frac{δ}{2}} A ( θ , φ ) \cdot ( a - Fb ( ISD , h , r , θ , φ ) )} ,$$

where I is an integer greater than or equal to two, referring to a number of said second networks (of the aerial type) comprising access devices likely to interfere with said communication,
Fb is the land impact factor,
Fᵢ the impact factor of a said second network,
Pᵢ the transmission power of each interfering access device of a said second network,
Gᵢ: the gain of each interfering access device of a said second network,
Kᵢ a propagation constant of each interfering access device of a said second network,
Gb: the gain of the land base stations,
Nₜₕ the thermal noise,

$$a = \frac{1}{{2}^{\frac{{D}_{u}}{W}} - 1}$$

where Dᵤ is the useful rate of data reception by the user device on the downlink radio link, and
W is the bandwidth used by the communication on the downlink radio link between the serving base station and the user device.

One advantage of this embodiment of the development is that it makes it possible, via geometric considerations, to obtain a very simple expression based on an integral of the power received from the other interfering base stations of the first network and from the other interfering access devices of the other networks (of the aerial type), which depends only on the impact factors, the antenna gains and the transmission powers of the access device of the first and second networks. According to another embodiment of the development, the quality-of-service parameter belongs to a group comprising at least:
a useful rate of data reception by the user device;
a useful delay of data transmission to the user device;
a useful power of data reception by from the user device.

According to a particular embodiment, the quality-of-service parameter comprises a useful rate of data transmission and the useful rate (315) is derived from the expression of the transmission power by the serving base station and determined according to the following equation:

$${D}_{u} = W {Log}_{2} ( 1 + \frac{1}{\begin{matrix}{F}_{b} ( ISD , h , r , θ , φ ) + \frac{{F}_{sat} {G}_{sat} {P}_{sat} {K}_{sat}}{{G}_{0} {{KP}_{b} ( {r}^{2} + {h}^{2} )}^{- \frac{δ}{2}} A ( θ , φ )} + \\ \frac{{N}_{th}}{{KP}_{b} {{G}_{0} ( {r}^{2} + {h}^{2} )}^{- \frac{δ}{2}} A ( θ , φ )}\end{matrix}} )$$

One advantage is that the actual value of the useful rate is obtained in a relatively simple manner. According to another embodiment of the development, the quality-of-service parameter comprises a useful delay Delᵤ of data transmission which is derived from the determined transmission power, by implementing a relation equivalent to the following relation:

$${DeI}_{u} = V / ( W {Log}_{2} ( 1 + \frac{1}{\begin{matrix}{F}_{b} ( ISD , h , r , θ , φ ) + \frac{{F}_{sat} {G}_{sat} {P}_{sat} {K}_{sat}}{{G}_{b} {{KP}_{b} ( {r}^{2} + {h}^{2} )}^{- \frac{δ}{2}} A ( θ , φ )} + \\ \frac{{N}_{th}}{{KP}_{b} {{G}_{b} ( {r}^{2} + {h}^{2} )}^{- \frac{δ}{2}} A ( θ , φ )}\end{matrix}} )$$

where V refers to a transmitted volume of data.

According to another aspect of the development, the monitoring method according to the development comprises determining a third impact factor associated with other interfering access devices of a third communication network, such as drones, according to a density (ρ_{d}) of drones interfering with the communication in a drone interference zone (CSd) defined at least according to an altitude of the drones of the third network and to a minimum angle of elevation of a said drone with the user device, and in that said determination (315) implements the following equation:

$${D}_{u} = W {Log}_{2} ( 1 + \frac{1}{\begin{matrix}{F}_{b} ( ISD , h , r , θ , φ ) + \frac{{F}_{sat} {G}_{sat} {P}_{sat} {K}_{sat} + {F}_{d} {G}_{d} {P}_{d} {K}_{d}}{{G}_{0} {{KP}_{b} ( {r}^{2} + {h}^{2} )}^{- \frac{δ}{2}} A ( θ , φ )} + \\ \frac{{N}_{th}}{{KP}_{b} {{G}_{0} ( {r}^{2} + {h}^{2} )}^{- \frac{δ}{2}} A ( θ , φ )}\end{matrix}} )$$

where Fd is the impact factor of the drones of the third network on the communication between the serving base station and the user device,
β_{d} is the density of interfering drones,
P_{d} the transmission power of a said interfering drone,
G_{d}: the gain of a said interfering drones, and
K_{d} a propagation constant of the drones.

Thus, it is relatively easy to take into account the impact of the access devices of the various networks near the user device.

According to another aspect of the development, said at least one transmission feature belongs to a group comprising at least:
a transmission power of at least one antenna of the serving device;
a gain of said at least one antenna;
a transmission bandwidth of said at least one antenna,
a transmission power of at least one antenna of at least one other interfering access device,
a gain of said at least one antenna of at least one other interfering access device;
a transmission bandwidth of said at least one antenna of at least one other interfering access device.

One advantage is that it is possible to act on the antenna(s) of the serving access device and/or on those of the interfering access devices, of the first network or of another network present in the geographical zone in which the user device is located.

The development also relates to a device for controlling a quality-of-service level of a communication between a user device and a first wireless communication network, said first network comprising a plurality of access devices configured to transmit radio frequency beams in a given frequency band.

Said device is configured to implement:
determining a value of a parameter representative of the quality-of-service level of the communication between a first access device of said plurality, to which said user device is attached, referred to as serving access device, at least according to a bandwidth allocated to this communication, to transmission features of the serving access device, to at least one other access device of the first network and to at least one other access device of at least one second wireless communication network, said other access devices of the first network and of the at least one second network being configured to transmit radio frequency beams in the given frequency band and being likely to interfere with the communication, and to a topology of the first network and of the at least one second network in at least one zone referred to as interference zone;
when the determined value does not reach a target value of said parameter, determining a modification of at least one transmission feature of at least one antenna of said serving access device and/or one other access device of the plurality and/or at least one second network, according to the target value.

For example, said parameter value is determined at least according to the bandwidth allocated to this communication, to a distance between the user device and the serving access device, to a transmission power of the serving access device, to antenna gain ratios of the serving access device, of said at least one other access device of the first network and of said at least one other access device of the at least one second network, and to the topology of the first network and of the at least one second network in said at least one interference zone.

Advantageously, said control device is integrated into the serving device of the first communication network. As a variant, it can be integrated into another access device of the first communication network or into the user device.

In one embodiment, said control device is integrated into a communication system, comprising access devices of the first network, including the serving device of the user device, and access devices of at least one second network, said access devices being configured to transmit radio frequency beams in a given frequency band, said system further comprising the user device and the aforementioned control device.

The communication system and the control device have at least the same advantages as those conferred by the above-mentioned monitoring method.

The development also relates to a computer program product comprising program code instructions for the respective implementation of the above-mentioned monitoring method, when it is executed by a processor.

A program can use any programming language, and can be in the form of source code, object code, or intermediate code between source code and object code, such as in a partially compiled form, or in any other desirable form.

The development also relates to at least one computer-readable storage medium on which is saved a computer program comprising program code instructions for implementing the steps of the method according to the development as described above.

Such a storage medium can be any entity or device able to store the program. For example, the medium can comprise a storage means, such as a ROM, for example a CD-ROM or a microelectronic circuit ROM, or a magnetic recording means, for example a mobile medium (memory card) or a hard disk or SSD.

On the other hand, such a storage medium can be a transmissible medium such as an electrical or optical signal, that can be carried via an electrical or optical cable, by radio or by other means, so that the computer program contained therein can be executed remotely. The programs according to the development can be downloaded in particular on a network, for example the Internet network.

Alternatively, the storage medium or media can be one or more integrated circuits in which the program is embedded, the circuit(s) being adapted to execute or to be used in the execution of the above-mentioned method.

According to an embodiment, the present technique is implemented using software and/or hardware components. In this context, the term “module” may be used in this document to refer to a software component, a hardware component or a combination of hardware and software components.

A software component is one or more computer programs, one or more subroutines of a program, or more generally any element of a program or software capable of implementing a function or set of functions, as described below for the module concerned. Such a software component is executed by a data processor of a physical entity (user device, serving, gateway, set-top-box, router, etc.) and is able to access the hardware resources of this physical entity (memories, recording media, communication buses, electronic input/output cards, user interfaces, etc.). Hereafter, resources are understood to be any set of hardware and/or software elements that support a function or a service, whether individually or in combination.

In the same way, a hardware component is any element of a hardware assembly capable of implementing a function or set of functions, as described below for the module concerned. It may be a programmable hardware component or a component with an embedded processor for executing software, for example, an integrated circuit, a smart card, a memory card, an electronic card for executing firmware, etc.

Each component of the system described above naturally implements its own software modules.

The various embodiments mentioned above can be combined with each other for the implementation of the present technique.

### BRIEF DESCRIPTION OF THE DRAWINGS

Other purposes, features and advantages of the development will become more apparent upon reading the following description, hereby given to serve as an illustrative and non-restrictive example, in relation to the figures, among which:

FIG. 1 diagrammatically shows the various elements involved in implementing the present solution, for a user device connected to a first access device, referred to as serving device, of a first communication network located in a geographical zone in which this first access device coexists with other access devices of other communication networks, configured to transmit radio signals in the same frequency band;

FIG. 2 shows an illustrative example of the architecture of a system comprising the serving device of the first communication network, the user device, at least one second communication network and a Device for controlling the quality-of-service level of a communication between the serving device and the user device according to the development;

FIG. 3 shows the steps of a method for monitoring a quality-of-service level of a communication between the serving device and the user device according to one embodiment of the development;

FIG. 4a shows a user device connected to a serving land base station of a first communication network;

FIG. 4B shows the sectors covered by three sector antennas of the serving land base station;

FIG. 5 diagrammatically shows an example of the relative positions of a user device and a satellite access device of the second communication network;

FIG. 6 describes in detail determining a useful rate for receiving the data transmitted by the serving access device of a communication network to a user device according to one embodiment of the development;

FIG. 7 diagrammatically shows an example of the relative positions of a user device and a radio access device of the drone type of a third communication network present in the geographical zone; and

FIG. 8 shows an example of the hardware structure of a device that allows implementing the steps of the method for monitoring a quality-of-service level according to one embodiment of the development.

### DETAILED DESCRIPTION OF CERTAIN ILLUSTRATIVE EMBODIMENTS

### General Principle of the Development

The development relates to the monitoring of a quality-of-service level of a communication established on a downlink radio link between an access device, referred to as serving device, of a first wireless communication network and a user device located in a geographical zone where other wireless communication networks coexist with the first network and whose access devices use the same resources as the first network, and in particular the same frequency band. Therefore, these other access devices, when transmitting radio frequency beams on this frequency band, are likely to generate interference with the radio frequency beams transmitted by the serving device on this same frequency band to the user device. For purposes of simplification, it is said that these other access devices are therefore likely to interfere with the communication between the serving device and the user device, and are referred to as interfering access devices.

The general principle of the development is based on determining a value of a parameter representative of an actual quality-of-service level of the communication between the serving device of the first network and the user device at least according to a bandwidth allocated to this communication, to transmission features of the serving device, to at least one other access device of the first network and to at least one other access device of at least one second wireless communication network, said other access devices being likely to interfere with the communication, and to a topology of the first network and of the at least one second network in at least one zone referred to as interference zone;

In the embodiment described here, the parameter value is determined at least according to the bandwidth allocated to this communication, to a distance between the user device and the serving device, to a transmission power of the serving device, to antenna gain ratios between the serving device and said at least one other access device of the first network and between the serving device and said at least one other access device of the at least one second network, and to the topology of the first network and of the at least one second network in said at least one interference zone.

According to the development, the determined value is compared with a target value of said parameter.

In this way, the development makes it possible to check that the target quality-of-service level is achieved and, if not, to propose a modification to the configuration of one or more access devices of the first network and/or of other networks present in the geographical zone and likely to interfere with the communication, to ensure that it is achieved.

A parameter representative of a quality-of-service level refers here to any parameter which makes it possible to characterise a data transmission performance on the radio link in question. It can be for example a useful rate of data reception by the user device UE or a delay of data transmission or a useful power of data reception.

The modification of a configuration of the transmission features may concern one or more antennas of the serving device to which the user device is connected, but also one or more antennas of one or more other access devices of the first network or of other communication networks present in the geographical zone in question.

The modified transmission features may include, for example, the antenna gain, the transmission power or the transmission bandwidth in the frequency band in question.

The development thus enables a user device to be guaranteed the quality of service and performance required to run a given service, for example by an application installed on a mobile terminal, of the smartphone type. It can advantageously be integrated into a planning tool used by an operator to decide where to locate their access devices in a given geographical zone.

The development works with both SISO (Single Input Single Output) and MIMO (Multiple Input Multiple Output) technologies.

The first network and the other communication networks are distinct and potentially heterogeneous in the sense that they can rely on different technologies and include access devices of different types. For example, the first network is communication network of the land type comprising land base stations and the second network is communication network referred to as of the “aerial” type comprising access devices located in the air, such as drones, or in space, such as satellites. Of course, the development is not limited to this example of a second satellite network and applies to other types of network, such as a network of drones or a network of high-altitude platforms. It is also assumed that the user device can be attached to any type of access device belonging to any of the aforementioned communication networks.

Hereafter, the case of a first communication network of the land type, for example based on a radio access technology of the OFDMA type, such as a mobile communication network compliant with one of the current 4G LTE-A or 5G versions or a future version (6G and following) defined by the 3GPP standard, is described. In the example detailed below, we consider a second satellite communication network (“aerial” network in the sense of the development) also implementing a radio technology of the OFDMA type compliant with the 3GPP standard in one of its versions from the fourth generation onwards (4G onwards), and likely to interfere in a given geographical zone with communications transmitted via the first land communication network.

Of course, the development is not limited to this example and applies more generally whatever the type of wireless communication network and implemented radio technology, provided that their access devices are configured to transmit on the same frequency band.

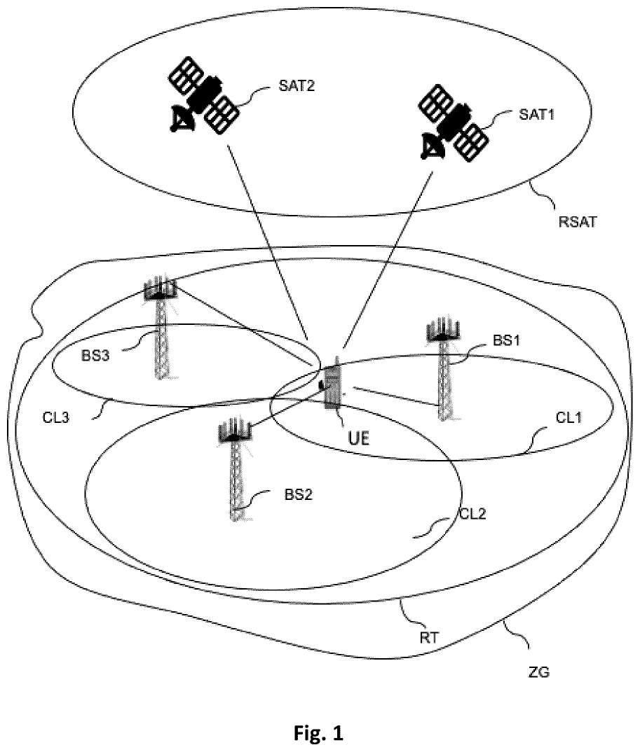

In relation to FIG. 1, a user device UE is presented, for example a mobile phone or a laptop or any other radio transmitter/receiver integrated in a vehicle or in a connected object located in a geographical zone ZG, connected to a first radiocellular communication network R_{T} of an operator. For example, an urban or semi-urban zone in which several land base stations BS1, BS2, BS3 of the network R_{T} have been set up close to one another. Their radio coverage zones or cells CL1, CL2, CL3 may overlap and, depending on its location in the zone ZG, the user device UE may be simultaneously within radio range of several of them.

In this example, above the geographical zone ZG, there are various satellite access devices SAT1, SAT2, located in orbit around the Earth at approximately 600 km, these satellite access devices belonging to a second satellite radio communication network RSAT. It should be noted that, although only a few satellite access devices belonging to a single satellite network RSAT were shown within the zone ZG, their number is actually much higher, ranging from a few units to several tens of units depending on the size of the considered geographical zone, as they may belong to a plurality of separate networks.

This second network RSAT may or may not be managed by the same operator as the first network. Each access device in the zone ZG is equipped with one or more antennas configured to transmit one or more radio frequency beams in one or more propagation directions, in a way that is known per se.

It is assumed hereafter that the user device UE is attached to the base station BS1 of the first network RT.

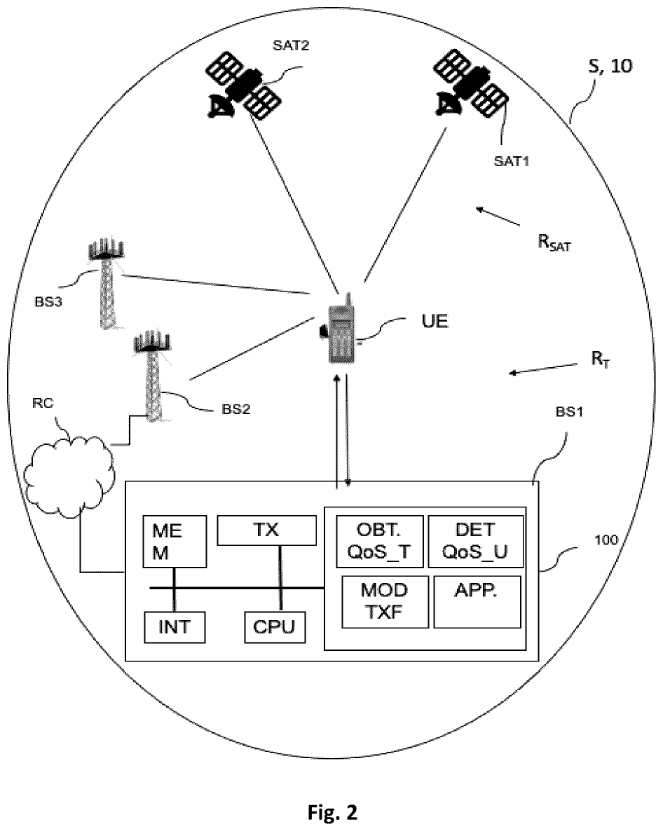

In relation to FIG. 2, an example of the architecture of a system S, 10 according to one embodiment of the development is now described. Such a system comprises access devices of a first communication network RT, access devices of a second network RSAT and the user device UE shown in FIG. 1. According to the development, the system 10 further comprises a device 100 configured to monitor a quality-of-service level of a communication established between the user device UE and a serving base station, namely in the example considered here, the serving base station BS1.

In this embodiment, such a device comprises a module DET. QoS_U for determining a value of a parameter representative of the quality-of-service level of the communication between the serving base station BS1 and the user device UE, at least according to a bandwidth allocated to this communication, to a distance between the user device and the serving base station BS1, to a transmission power of the serving base station and to antenna gain ratios between the serving base station and at least one other access device of the first network and between the serving device and at least one satellite of the second network RSAT configured to use said given frequency band and likely to interfere with the communication, and to a topology of the first network R_{T} and of the at least one second network RSAT in at least one zone referred to as interference zone. The device also comprises a module MOD. TXF for obtaining a modification of at least one transmission feature of said serving access device and/or of at least one other access device of the first and/or of the at least one second network, according to the target value, configured to be implemented when the determined value does not reach a target value of said parameter. Advantageously, it also comprises a module OBT. QoS_T for obtaining the target value of the parameter representing the quality-of-service level and a module APP for applying the obtained modification.

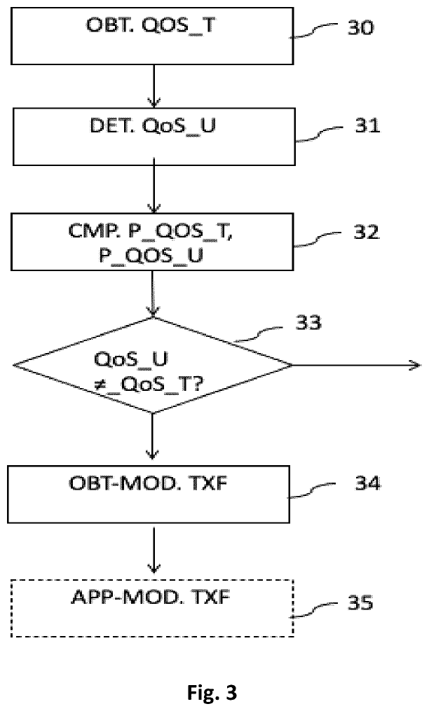

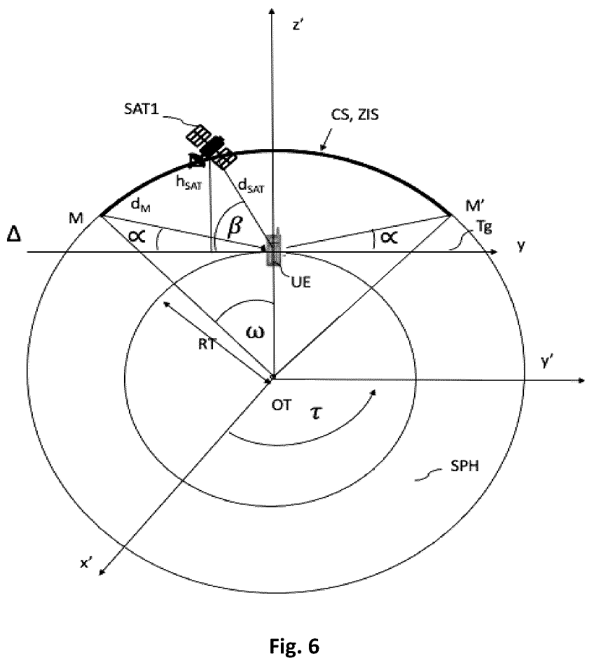

The device 100 thus implements the method for monitoring a quality-of-service level according to the development that will be described in more detail in relation to FIGS. 3 and 6.

In the example of FIG. 2, the device 100 is housed in the first network RT and, for example integrated into the base station BS1, which typically comprises memories MEM associated with a processor CPU. The memories can be of type ROM (Read Only Memory), RAM (Random Access Memory) or Flash. The base station BS1 also includes a module TX configured to control the transmission/reception of radio frequency beams by its antenna(s) (not shown) depending on the type of technology used. It also comprises another interface INT, for example wired, for communicating with node devices in a core part RC of the first communication network RT. As a variant, the device 100 could be integrated into another radio access device of the first network R_{T} or into a node device of the core network RC. According to another variant, it is integrated to the user device UE.

In relation to FIG. 3, the steps of the method for monitoring a quality-of-service level according to one embodiment of the development in the environment illustrated by FIG. 2 are now presented.

In a step 30, a target value QoS_T of a parameter representative of a quality-of-service level of a communication established on the downlink radio link between the serving base station BS1 and the user device UE is obtained.

For example, this target value is received from the user device UE in a request message transmitted by a dedicated application installed on the user device UE. It can be for example an application implementing video data streams and which needs in order to operate a target useful rate of data reception and/or a target bandwidth in order to guarantee the quality of the images rendered to the user, or an application which implements voice streams which needs a transmission delay that is less than a target value in order to guarantee a real-time communication.

As a variant, the target value of the parameter can be stored in memory, for example in a data table of the first network R_{T} storing a profile of the user or a quality-of-service configuration associated with the application in question and accessible by the device 100.

In 31, an actual value of the quality-of-service parameter is determined for a data transmission on the downlink radio link between the serving base station and the user device UE, at least according to a bandwidth allocated to this communication, to a distance between the user device and the serving base station, to a transmission power of the serving base station BS1 and to antenna gain ratios between the serving base station and at least one other access device of the first network and between the serving device and at least one satellite of the second network RSAT configured to use said given frequency band and likely to interfere with the communication, and to a topology of the first network R_{T} and of the at least one second network RSAT in at least one zone referred to as interference zone. A detailed example of determining this parameter will be described below in relation to FIG. 6.

In 32, the actual value of the quality-of-service parameter determined in 31 is compared with the target value previously obtained.

Depending on the result of this comparison, it is decided in 33, when the actual value reaches the target value, that the configuration of the communication system 10 can be left as it is, and otherwise to modify the value of at least one transmission feature TXF of at least one antenna of at least one access device of the communication system 10. It is understood that depending on the type of parameter representative of a quality-of-service level considered, the actual determined value may not reach the target value as it is lower than the target value (for example in the case of a useful rate of data reception) or on the contrary as it is higher than the target value (for example in the case of a useful delay of data reception).

As a variant, it can also be considered, when the actual value reaches and exceeds the target value, to modify the value of at least one transmission feature TXF of at least one antenna of at least one access device of the communication system 10, for example to optimise the transmission parameters of the communication system 10 further, while ensuring that the target rate requirement is still met.

In 34, the required modification is determined. It may be intended to apply to the antenna(s) of the serving base station BS1 or to the antennas of other access devices of the first network R_{T} and/or the second network RSAT located in the interference zone.

For example, it is assumed that the quality-of-service parameter taken into consideration is the useful rate of data reception by the user device and that the actual determined value is less than the target value.

According to a first embodiment of the development, the decided modification comprises an increase in the transmission power of the base station BS1. As a variant, it comprises a decrease in the transmission power of other access devices, for example satellites SAT1, SAT2 of the second network RSAT or potentially other base stations BS2 and BS3 of the first network RT.

According to a second embodiment, the modification relates to a bandwidth of the communication system, i.e. in the frequency bandwidth actually used by the system within the authorised frequency band. For example, the frequency band authorised by the 3GPP standard in a network is approximately comprised between 2,680 and 2,690 MHZ, namely a 10 MHz bandwidth, whereas the bandwidth of the frequencies actually used by an access device is only 2 or 3 MHz. This bandwidth can therefore be increased or decreased to meet the rate requirement and optimise the use of the bandwidth allocated to transmission.

According to a third embodiment of the development, the modification relates to the antenna gain of the base station BS1 if such a possibility of modifying the antenna gain of the base station is offered by the network RT.

According to another embodiment, the modification relates to several of the above-mentioned transmission features.

In 35, the obtained modification is implemented. Several embodiments can be considered. Upstream of a communication: it then enables the operator of the first network to know whether a serving access device likely meets a quality of service requested by a user device. Implementation 35 of the obtained modification may involve sending a control message to update a configuration of the access device, specifying the new value of the transmission feature(s) concerned. If it is not possible to modify the transmission features of the serving access device as determined in 34, an alert message can be transmitted to another device or another function of the first network, for example in charge of supervising quality-of-service management, so that it triggers various actions aimed at improving the user experience (informing the user, rejecting the communication, selecting another access device to serve the communication, etc.). As a variant, it can be considered to take this impossibility into account and to determine a modification that can be applied to another access device of the first network and/or the second network. Alternatively, when the obtained modification concerns other access devices of the first network or interfering access devices of the second network, control messages for updating their configuration are sent directly to them, in the case where the operator of the first network is also the operator of the second network. Otherwise, when the second network is operated by another operator, an update request message may be sent to the second network, in accordance with the terms of an inter-operator agreement.

The obtained modifications can also be applied during a communication to adapt one or more transmission features of this communication dynamically, such as the transmission power of the serving access device, the bandwidth allocated to the communication or the communication rate.

Alternatively, the development can also be implemented in a tool for planning the deployment of land access devices, in the air or in space, for example to adapt the transmission features of the access devices of the first and/or the second network, following the implementation of a new base station in the first network or the placing into orbit of an additional satellite in the geographical zone in question.

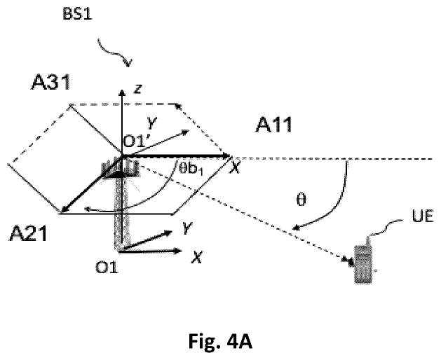

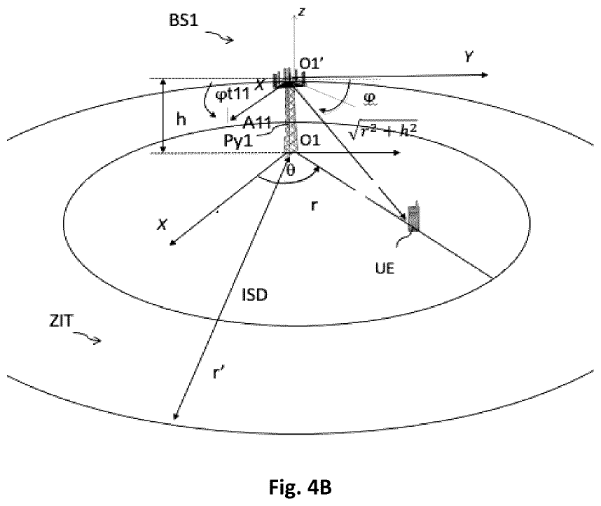

An example of determining an actual value of a quality-of-service parameter (step 31 of the method just described) according to one embodiment of the development is now described below. In this example, the user device UE is still considered to be attached to the serving base station BS1, an example of the configuration of which is now described in relation to FIGS. 4A and 4B.

In the present application, a base station is defined as being dedicated to the management of a given geographical site (for example, the geographical site of the base station BS1 corresponds to the cell CL1 of the network). In the case of FIG. 4A, the first base station BS1 manages the corresponding geographical site on a multi-sector basis. More specifically, the first base station BS1 of FIG. 4A covers the site via three distinct sectors, each sector being covered by an antenna referred to as corresponding sector antenna A11, A21, A31. In the present application, a sector antenna is defined as an antenna transmitting mainly in a given propagation direction. For example, a cell of the radiocommunication network comprises three sectors. The three sectors are assumed here to be identical in size. For the sake of simplicity, it is assumed that each sector is defined by a steering angle, θ b₁ in the horizontal plane, which in this example is e b₁=120°. It should be noted that other steering angle values can be chosen.

Each sector is covered by means of a single antenna A11, A21, A31 able to transmit according to a single beam in a given propagation direction (or at least a single main beam concentrating most of the power radiated by the antenna) over a given band of frequencies. In FIG. 4A, for the sake of simplicity, this propagation direction is referenced in a similar way to the corresponding antenna A11, A21 or A31. In other words, propagation (or radiation) directions of the beams transmitted by the antennas A11, A21, A31 covering two adjacent sectors of this site have an angle between them that is equal to 0 b₁. Each antenna A11, A21, A31 is characterised, in a manner known in itself, by a radiation pattern.

For example, antennas as described in the ITU-R Report M.2135-1 document from ITU-R, entitled “Guidelines for evaluation of radio technologies for IMT Advanced” of December 2009 are considered. The radiation pattern of each antenna A11, A21, A31 has an opening angle at three decibels in the horizontal plane noted θ_{3dB}.

The antennas A11, A21 and A31 are co-located at the base station BS1, which is located at a point of the cell covered by the base station BS1, for example at the centre O1 of the cell in the example shown in FIG. 4A. “Co-located” means that the antennas A11, A21, A31 are located at the same site (i.e. the same base station). However, they are not necessarily positioned at the same geographical point (corresponding to an ideal distance of zero between the antennas) and may be separated by a few centimetres or a few tens of centimetres, or even a few metres. For example, the antennas may be spaced at a distance of less than λ/2 where A is the wavelength of the signals transmitted by antennas A11, A21 and A31 to communicate over the network. As a variant, they can be spaced at a distance greater than λ/2. It should be noted that in an urban environment, the preferred spacing is less than 3 to 5 metres; in a rural environment, a greater spacing may be considered, as the cells cover larger zones.

In the example considered here, for the sake of simplicity, it is assumed that the antennas A11, A31 and A21 are located at the same point O1′ at the top of a pylon of the base station BS1. As shown in FIG. 4A, the user device UE is identified by the first base station BS1 in an orthonormal coordinate system O1xyz. Here, the origin O1 of the coordinate system is located at the bottom of the pylon of the base station BS1 supporting the antennas A11, A21 and A31, at ground level. The axis O1z is vertical (along the pylon in this case, parallel to it) and axes O1x and O1y define a horizontal plane parallel to the ground and perpendicular to the pylon. In this example considered here, the plane (O1xy) is at ground level and is tangent to the Earth's surface at point O1 at the bottom of the pylon. The axis O1x coincides with the projection of the main propagation direction of the antenna A11 onto this horizontal plane parallel to the ground. The direction of observation of the user device UE by an antenna of the base station is referred to here as its direction seen by this antenna. The coordinate system O1′xyz whose origin O1′ is located at the top of the pylon, at a height h from the ground, and more particularly at the point where the antenna A11 is located (and in the example considered here, the two antennas are assumed to be co-located at the same point for the sake of simplicity, as mentioned above) is also considered.

For example, the user device UE is located via angles of a spherical coordinate system (θ11, ϕ11) in the coordinate system O1′xyz in question, and by the distance r representing the projection in the horizontal plane O1xy of the distance of the user device UE from the origin O1′ of the coordinate system O1′xyz. For the sake of simplicity, it is assumed here that the user device UE is located in the horizontal plane O1xy, at ground level (the height of the user device UE from the ground is disregarded). In other words, in FIG. 4B, r represents the distance of the user device UE from the bottom of the pylon located at O1, supporting the antennas A11, A21, and e 11 and ϕ 11 representing respectively the longitude and the latitude of the user device UE in the coordinate system O1′xyz. The angle θ11 is thus defined via the projection of the vector joining the origin of the coordinate system O1′xyz to the user device UE in the horizontal plane O1xy, and measured with respect to the projection of the main direction of propagation of the antenna A11 in this plane (which coincides with the direction O1x). The coordinates (r, θ, ϕ) define the relative position of the user device UE with respect to the base station BS1, that is by taking the position of the first base station BS1 as a reference. This position of the base station BS1 is known to the first network RT.

The antennas A11, A21, A31 transmit radio frequency beams at a tilt angle ϕ t11 corresponding to a steering angle (a steering latitude in this case) in their radiation pattern relative to the horizontal plane O1′xy.

Sector antennas such as A11, A21 and A31 are for example adapted to an implementation referred to as SISO (Single Input Single Output) of the radio communication network in question, but also to a MIMO implementation, in which the sector antennas are arrays or networks of radiating elements. In the following, an embodiment of the development is described in the SISO case.

In FIG. 4A, the antennas A11, A21 and A31 are at a height h which corresponds to the distance between the antennas and the ground. In other words, the plane O1′xy is at a height h from the plane O1xy.

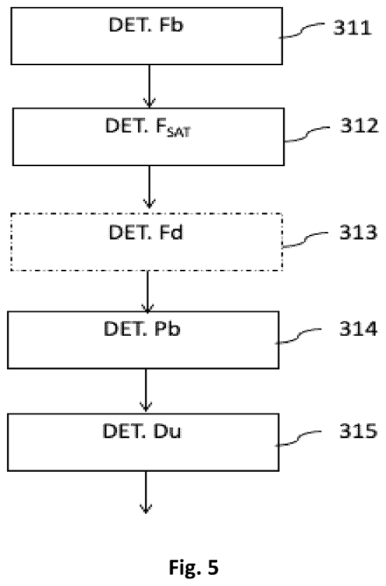

In relation to FIG. 5, an example of determining the actual value of a quality-of-service parameter according to one embodiment of the development is now described. In this example, the user device UE is attached to the serving base station BS1 of the first network R_{T} of FIG. 2 and the base station BS1 has the architecture shown in FIGS. 4A and 4B. It is assumed here that the user device UE receives one or more radio frequency beams from the antenna of the first sector of the serving base station BS1.

In 311, a land impact factor Fb of the other land base stations on the quality-of-service level of the downlink radio link between the base station BS1 and the user device UE is determined. According to the development, this impact factor depends on a density of the other land base stations of the first network likely to interfere with the communication between the serving base station BS1 and the user device, i.e. located in a land interference zone (ZIT in FIG. 4B). These are referred to as interfering base stations. This land interference zone ZIT is defined as a rim centred on the serving base station BS1, a first radius of which being the average inter-site distance ISD and a second radius of which being the boundaries of the geographical zone ZG.

This land impact factor Fb represents the sum of the powers of each of the base stations of the first network R_{T} which are located in the land interference zone ZIT.

A first simplifying assumption is that all base stations of the first network R_{T} transmit with the same given transmit power and maximum antenna gain.

A second is to consider that the sum of the discrete contributions of the powers transmitted by the base stations located in the land interference zone can be transformed into a continuous spherical integration of the density of the interfering base stations all around the base station, thus over an angular interval [0, 2π] and for a radius r′ between ISD and a maximum value defined by the boundaries of the geographical zone ZG.

A third assumption is that the user device UE is served by the antenna(s) of the first sector of the serving base station BS1.

A fourth assumption is that the antennas of the other sectors of the serving base station use the same frequency band and are therefore likely to generate interference with the communication.

On the basis of these assumptions, the inventor established that this land impact factor could be defined using the following relation:

$$Fb ( ISD , h , r , θ , φ ) = \frac{{ρ}_{B} {{V}_{1} ( ISD - r )}^{2 - δ} {\int }_{0}^{2 π} {H}_{1} ( θ ) d θ}{( δ - 2 ) {( {r}^{2} + {h}^{2} )}^{- \frac{δ}{2}} A ( θ , φ )} + {\sum }_{2}^{3} \frac{A ( {θ}_{k} , {φ}_{k} )}{A ( θ , φ )} , \qquad ( 2 )$$

where ISD is the average distance between the serving base station and the interfering base stations,
β_{B} is the density of base stations in the land interference zone,
δ is the path-loss factor which models propagation attenuation,
r is the radius or distance between the user device and the first antenna,
h is the height of the first antenna relative to the user device,
(r, θ, ϕ) is the spherical coordinates of the user device in a coordinate system O1′xyz centred on the serving base station at ground level,
θ is the angle of elevation between the user device and said first antenna,
ϕ is the horizontal angle between the user device and said first antenna,
A(θ, φ) is the angular gain of the first antenna of the serving base station, to which the user device UE is connected.

The user device UE is connected to the first sector of the serving base station BS1, whose antenna gain is therefore A(θ, φ)_{dB}.

It receives interfering powers from all the other antennas of the first network.

This interference is proportional to:

$$\frac{{ρ}_{B} {{V}_{1} ( ISD - r )}^{2 - δ} {\int }_{0}^{2 π} {H}_{1} ( θ ) d θ}{( δ - 2 ) {( {r}^{2} + {h}^{2} )}^{- \frac{δ}{2}}}$$

It also receives interference from the other two sectors, which in this example use the same frequency band as the first sector. This interference is proportional to A(θ₂, φ₂)+A(θ₃, φ₃).
A(θₖ, φₖ) the angular gain of each of the two other antennas (k=2, 3) of the serving base station, co-located with the first antenna of the serving base station.
H1 is the gain of each antenna of the first network RT, defined as follows by:

$${{H}_{1} ( θ )}_{dB} = - min [ - {H ( θ )}_{dB} , {A}_{m} + {V}_{1 , dB} ] ,$$

where Am refers to the minimum antenna gain, and

$${V}_{1 , dB} = - min [ 12 {( \frac{{φ}_{tilt}}{{φ}_{3 dB}} )}^{2} , {A}_{m} ] with {H ( θ )}_{dB} = - min [ 12 {( \frac{θ}{{θ}_{3 dB}} )}^{2} , {A}_{m} ]$$

is a constant,

$${V ( φ )}_{dB} = - min [ 12 {( \frac{φ - {φ}_{tilt}}{{φ}_{3 dB}} )}^{2} , {A}_{m} ]$$

where φₜᵢₗₜ is the downward tilt angle, φ_{3dB} the vertical beamwidth at half-power, θ_{3dB} the horizontal beamwidth at half-power, and a contribution from the other two antennas of the serving base station uses a relation equivalent to the following:

$${\sum }_{2}^{3} \frac{A ( {θ}_{k} , {φ}_{k} )}{A ( θ , φ )} = \frac{( {θ}_{2} , {φ}_{2} ) + ( {θ}_{3} , {φ}_{3} )}{A ( θ , φ )}$$

where k=2,3 respectively refers to the other two antennas of the serving base station.

Thus, according to this embodiment of the development, it is not useful to know the absolute positions of each of the other base stations in the geographical zone ZG. On the contrary, the development proposes to estimate in a simple and global manner their impact on the communication established on the downlink radio link between the base station BS1 and the user device UE.

In 312, a satellite impact factor FSAT is determined according to a density of satellites of the second network placed into orbit above the geographical zone ZG and likely to interfere with the communication.

They are referred to hereafter as interfering satellites. In relation to FIG. 6, they are located in a satellite interference zone ZIS which is defined below.

In the embodiment described here, this is a spherical cap corresponding to a portion of the sphere SPH whose radius is the orbit of the satellites SAT1 SAT2 of the satellite network RSAT.

More specifically, the satellites of the satellite network RAT that simultaneously use for communication the same resources as the base station BS1 uses for downlink communication with the user device UE, such as, for example, the same frequency band, are considered likely to generate interference on the communication between the serving base station BS1 and the user device UE. It is assumed here that all satellites of the satellite network RSAT in direct line-of-sight with the user device UE satisfy this condition for the sake of simplicity, that is the satellites located in the sphere portion ZIS of the sphere SPH bounded by the horizontal A plane orthogonal to the Earth's radius R_{T} at a point where the user device UE is located (i.e. tangent to the Earth at the user device UE). It is noted that this assumption is realistic because in such a satellite network, a priori all the satellites of the network are used to transmit data to users of the satellite network and configured to exploit all the resources available to it in order to maximise network performance. As a result, the simultaneous use of the same resources by all the satellites of the satellite network is an assumption that a satellite network verifies with a high probability.

If this assumption is not verified for the given satellite network, it is sufficient to limit the study to the satellites located in the sphere portion ZIS simultaneously using the same resources (e.g. the same frequency band here) that the base station BS1 uses for downlink communication with the user device UE.

Furthermore, the inventor has noticed that below a certain angle of elevation with respect to the user device UE, noted a, typically α=30°, hereinafter referred to as minimum angle of elevation, the interference generated by the satellites located in the zone ZIS has only a slight impact on the performance of the communication between the serving base station BS1 and the user device UE and can be disregarded, so that in the remainder of the description, an interference zone ZIS corresponding to the spherical cap bounded by the disk parallel to the plane Δ corresponding to an angle of elevation with respect to the user device UE equal to a is considered. It should be noted that the value 30° is a typical value provided by satellite manufacturers, but the development applies to other values of a (for example, to values below) 30°.

In an ingenious manner, the inventor has assessed the interference generated by all the interfering satellites located in the zone ZIS thus defined on a global basis (rather than individually for each satellite). For this purpose, they have considered the topology of the satellite network RSAT in this zone ZIS and more specifically, in the embodiment described here, the density PSAT of the satellites likely to interfere with the communication located in the interference zone ZIS (i.e. number of satellites per area unit), the altitude hSAT of the interfering satellites, as well as the angle α of minimum elevation of the interfering satellites and therefore located in the interference zone ZIS (that is here α=) 30°.

As a variant, it is possible to consider other elements representative of the satellite network topology, such as the probability that a satellite will generate interference affecting the communication between the serving base station BS1 and the user device UE, in other words, the probability that the satellite in question will be located in the interference zone ZIS.

It should be noted that if the satellites of the satellite network have different altitudes, the same reasoning applies to each subset of satellites located at the same altitude, the overall contribution of the satellites being obtained by summing the contributions of each subset for each different altitude (a separate density is then considered for each different altitude).

In relation to FIG. 6, a spherical coordinate system (d_{SAT}, τ, β) centred on the user device is then considered, where d_{SAT} is the distance between the user device UE and the satellite SAT1, τ is the longitude angle (horizontal) and β the angle of latitude or elevation (vertical).

For such a satellite, located at an angle of elevation β, it can be shown by geometric considerations and the implementation of trigonometric relations that the distance d_{SAT} can be written as:

$${d}_{SAT} = - {R}_{T} sin ( β ) + \sqrt{{[ {R}_{T} * sin ( β ) ]}^{2} * {R}_{T} * {h}_{SAT} + {{h}_{SAT}}^{2}} \qquad ( 3 )$$

The density of satellites present in the satellite interference zone ZIS is expressed as follows:

$${ρ}_{SAT} = {N}_{SAT} / S \qquad ( 4 )$$

where N_{NSAT} is the number of interfering satellites in the zone ZIS and S is the area (not shown in FIG. 6) of the spherical cap CS in which the interfering satellites are in motion for the user device UE above the geographical zone ZG (which therefore corresponds to the zone ZIS). The spherical cap CS is located beyond the angles of minimum elevation α and π−α.

$$S = 2 {π ( {R}_{T} + {h}_{SAT} )}^{2} ( 1 - costhetamax ) \qquad ( 5 )$$

$$costhetamax = \frac{{R}_{T} + {d}_{SAT} sin α}{{R}_{T} + {h}_{SAT}}$$

where d_{M} is the distance between the user device UE and a satellite located at that angle α.

This distance d_{M} is written as:

$${d}_{M} = - {R}_{T} sin ( α ) + \sqrt{{[ {R}_{T} * sin ( α ) ]}^{2} * {R}_{T} * {h}_{SAT} + {{h}_{SAT}}^{2}} \qquad ( 6 )$$

To determine the impact factor F_{SAT}, the inventor has made the (realistic and highly probable) assumption that the gain ratio G and the power P are the same for all the satellites likely to interfere with the communication located in the zone ZIS: in fact, the antenna of a satellite transmits an extremely fine beam and if it is assumed that the user device UE is not within the coverage of the main lobe of the radiation pattern of the antennas of these satellites (which would otherwise be serving satellites for the user device UE), it is common to consider (cf. technical specifications for satellite networks) that the same gain applies in the direction of the user device UE outside this main lobe, for example −30 dB from the maximum gain of the main lobe of the antenna. In addition, to maximise the rate that can be achieved during a communication, it is common to configure (all) the satellites so that they transmit at the maximum authorised power Pmax(P=Pmax).

According to the development and on the basis of this assumption, the impact factor F_{SAT} is defined by the density ρ_{SAT} of interfering satellites in the interference zone ZIS, integrated by a spherical double integration corresponding to the surface S of the spherical cap CS.

The following is obtained:

$${F}_{SAT} = {ρ}_{SAT} \int {\int }_{α}^{π - ∝} sin ω \cdot d ω \cdot d τ \qquad ( 7 )$$

where τ varies between 0 and 2π.

The following expression for the factor F_{SAT} is thus deduced:

$${F}_{SAT} = {ρ}_{SAT} \frac{π * {( {R}_{T} + {h}_{SAT} )}^{2}}{( {R}_{T} * ( {R}_{T} + {h}_{SAT} ) )} log \frac{A}{B} \qquad ( 8 )$$

$$where$$

$$A = {( {R}_{T} + {h}_{sSAT} )}^{2} + {{R}_{tT}}^{2} - \frac{2 {R}_{T} ( {R}_{{T}^{\cdot }} + {h}_{SAT} ) ( {R}_{{T}^{\cdot }} + {d}_{M} sin ∝ )}{( {R}_{{T}^{\cdot }} + {h}_{SAT} )}$$

$$B = {( {R}_{T} + {h}_{SAT} )}^{2} + {{R}_{tT}}^{2} - 2 {R}_{T} ( {R}_{{T}^{\cdot }} + {h}_{SAT} )$$

In 314, the transmission power Pb from the serving base station to the user device UE is determined. Conventionally, the angular position of the user device UE relative to the base station BS1 and the radiation pattern of the antenna of the first sector of the base station BS1 which transmits at least one radio frequency beam intended for this user device. In relation to FIG. 4B that was already described, the radiation pattern characterises the gain of the antenna according to a direction of observation (θ, φ) of the user device UE in the coordinate system O1′xyz.

In addition, this determination takes into account the land Fb and satellite FSAT impact factors described above, which makes it possible to express the power received by the user device as follows:

$${P}_{b} = \frac{{G}_{SAT} {P}_{SAT} {K}_{SAT} {F}_{SAT} + {N}_{th}}{{GbKb ( {r}^{2} + {h}^{2} )}^{- \frac{δ}{2}} A ( θ , φ ) \cdot ( α - Fb ( ISD , h , r , θ , φ ) )} \qquad ( 9 )$$

$$where :$$

$$a = \frac{1}{{2}^{\frac{{D}_{u}}{W}} - 1}$$

W is the bandwidth used by the communication on the downlink radio link between the first base station and the user device,
Du the useful rate of data reception by the user device UE,
P_{SAT}: transmitting power of a satellite, based on the assumption that all satellites SAT1, SAT2 in the zone ZG transmit at the same power,
G_{SAT} the gain of the satellites
G_{b} the gain of the base stations,
K_{SAT} a propagation constant of the satellites
Kb a propagation constant of the base stations and.
Nₜₕ the thermal noise.

It is recalled that:
ISD refers to the average inter-site distance, in particular between the first serving base station BS1 and the other base stations in the first network RT,
K is a propagation constant of the base stations,
r refers to the distance separating the user device UE from the base station BS1 at ground level,
h is the height of the antennas of the serving base station from the ground,
δ is a path-loss factor which models the propagation attenuation with the distance,
A(θ, φ) is the angular gain of the antenna of the first sector of the serving base station BS1.

In 315, the useful rate of data reception by the user device UE can thus be deduced:

$${D}_{u} = W {Log}_{2} ( 1 + \frac{1}{\begin{matrix}{F}_{b} ( ISD , h , r , θ , φ ) + \frac{{F}_{sat} {G}_{sat} {P}_{sat} {K}_{sat}}{{G}_{b} {{KP}_{b} ( {r}^{2} + {h}^{2} )}^{- \frac{δ}{2}} A ( θ , φ )} + \\ \frac{{N}_{th}}{{KP}_{b} {{G}_{b} ( {r}^{2} + {h}^{2} )}^{- \frac{δ}{2}} A ( θ , φ )}\end{matrix}} ) \qquad ( 10 )$$

As a variant, another parameter representative of a quality-of-service level on the downlink radio link between the serving base station BS1 and the user device UE can be determined, such as the useful rate of reception DRu or the useful power of reception Pu.

For a volume V of data transmitted by the serving base station BS1, the transmission delay DRu can be written as follows:

$${DR}_{U} = V / ( W {Log}_{2} ( 1 + \frac{1}{\begin{matrix}{F}_{b} ( ISD , h , r , θ , φ ) + \frac{{F}_{sat} {G}_{sat} {P}_{sat} {K}_{sat}}{{G}_{b} {{KP}_{b} ( {r}^{2} + {h}^{2} )}^{- \frac{δ}{2}} A ( θ , φ )} + \\ \frac{{N}_{th}}{{KP}_{b} {{G}_{b} ( {r}^{2} + {h}^{2} )}^{- \frac{δ}{2}} A ( θ , φ )}\end{matrix}} ) \qquad ( 11 )$$

The development therefore makes it relatively easy to obtain the actual value of one or more parameters representative of a quality-of-service level of the communication between the serving base station BS1 and the user device UE.

According to another embodiment of the development, in addition to the first network R_{T} and the second network RSAT, a third communication network is considered, for example of the aerial type, comprising a plurality of access devices present in the air above the geographical zone ZG where the user device UE is located. It is assumed here that this is a network of drones RD and that the drones of this network use the same frequency band as the serving base station BS1 and are therefore likely to generate interference on the communication between the serving base station BS1 and the user device UE.

According to this example, in 313, an impact factor of the drones Fd is determined according to a density β_{d} of the drones Dr located in an interference zone of the drones ZID.

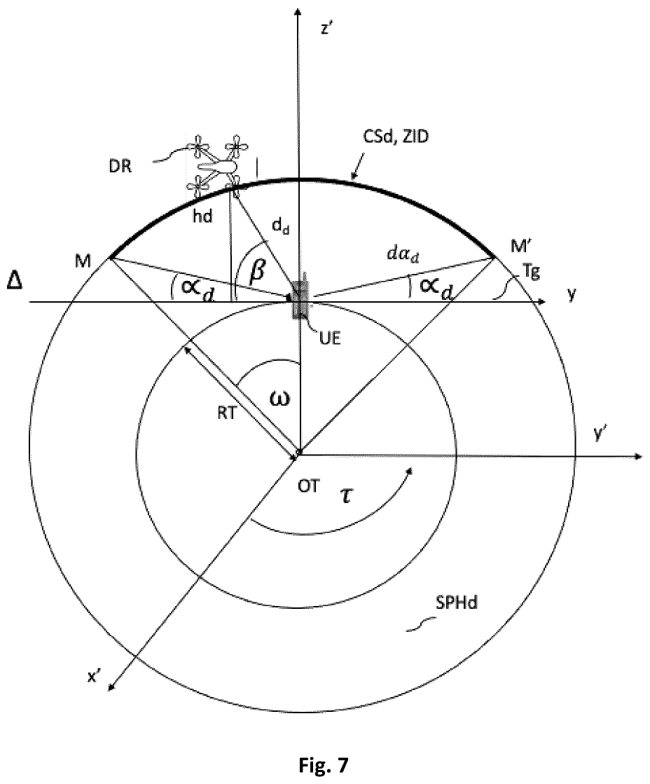

In relation to FIG. 7, it is assumed that the drones Dr present above the geographical zone ZG are positioned at an altitude ha, of about a few hundred metres, and the same assumptions are made as for the satellite network, namely that all the drones Dr transmit with the same power and the same gain and that the interference zone of the drones is defined as a spherical cap CSD of radius da and bounded by a minimum angle of elevation aa below which the drones do not generate interference with the communication between the serving base station BS and the user device UE.

On the basis of these assumptions, the impact factor Fa is defined by the density β_{d} of interfering drones in the interference zone ZID, integrated by a spherical double integration corresponding to the surface S_{d} of the spherical cap CS_{d}.

The following is obtained:

$${F}_{d} = {ρ}_{d} \int {\int }_{α d}^{π - ∝ d} sin ω \cdot d ω \cdot d τ \qquad ( 7 a )$$

where τ varies between 0 and 2π,
β_{d} refers to the density of interfering drones, i.e. located at a minimum angle of elevation α_{d} with respect to the horizontal plane Δ orthogonal to the radius R_{T} of the Earth at a point where the user device UE is located (i.e. tangent to the Earth at the user device UE).

One applies:

$${A}_{d} = {( {R}_{T} + {h}_{d} )}^{2} + {{R}_{tT}}^{2} - \frac{2 {R}_{T} ( {R}_{{T}^{\cdot }} + {h}_{d} ) ( {R}_{{T}^{\cdot }} + {d}_{{α}_{d}} sin {α}_{d} )}{( {R}_{{T}^{\cdot }} + {h}_{d} )}$$

$${B}_{d} = {( {R}_{T} + {h}_{d} )}^{2} + {{R}_{T}}^{2} - 2 {R}_{T} ( {R}_{{T}^{\cdot }} + {h}_{d} )$$

where R_{T} is the radius of the Earth,
h_{d} is the altitude of the drones. It is assumed here that they are all located at the same altitude for the geographical zone ZG,
d_{α}_{_{d}} is the distance between the ground receiver and a drone at the minimum angle of elevation α_{d}.

The density of interfering drones is determined as follows:

$${ρ}_{d} = {N}_{d} / Sd \qquad ( 4 a )$$

where N_{d} refers to the number of interfering drones present in the interference zone ZID and S_{d} the area of the spherical cap located between the minimum angles of elevation α_{d} and π−_{d}.

$${S}_{d} = 2 {π ( {R}_{T} + {h}_{d} )}^{2} ( 1 - {costhetamax}_{d} ) \qquad ( 5 a )$$

$$where {costhetamax}_{d} = \frac{{R}_{T} + {d}_{d} sin {α}_{d}}{{R}_{T} + {h}_{d}} .$$

The distance d_{α}_{_{d}} is written as:

$$d {α}_{d} = - {R}_{T} sin ( {α}_{d} ) + \sqrt{{[ {R}_{T} * sin ( {α}_{d} ) ]}^{2 {R}_{T} {h}_{d}} + {{h}_{d}}^{2}} \qquad ( 6 a )$$

The factor F_{d} of the expression (3a) is therefore written as:

$${F}_{d} = {ρ}_{d} \frac{π * {( {R}_{T} + {h}_{d} )}^{2}}{( {R}_{T} * ( {R}_{T} + {h}_{d} ) )} Log \frac{A}{B} \qquad ( 8 a )$$

In the case of a communication system S further including drones, the expression for the useful rate obtained in 315 becomes:

$${D}_{u} = W {Log}_{2} ( 1 + \frac{1}{\begin{matrix}{F}_{b} ( ISD , h , r , θ , φ ) + \\ \frac{{F}_{sat} {G}_{sat} {P}_{sat} {K}_{sat} + {F}_{d} {G}_{d} {P}_{d} {K}_{d}}{{G}_{b} {KP}_{b} . {( {r}^{2} + {h}^{2} )}^{- \frac{δ}{2}} A ( θ , φ )} + \\ \frac{{N}_{th}}{{KP}_{b} {G}_{b} . {( {r}^{2} + {h}^{2} )}^{- \frac{δ}{2}} A ( θ , φ )}\end{matrix}} ) \qquad ( 10 a )$$

where G_{d} refers to the gain of the drones,
P_{d} is the transmission power of the drones, and
K_{d} a transmission constant of the drones.

Of course, according to another embodiment, the presence of a fourth communication network in the geographical zone could be considered, for example a network of altitude platforms, and an impact factor of these platforms could be determined in a similar way to what has just been described in the case of a network of drones.

Once the actual or useful value of the quality-of-service parameter QoS_U, for example the useful rate Du, has been obtained, it is compared with the target value in 320 as previously described in relation to FIG. 3. When it is established in 330 that the actual value of the parameter representing a quality-of-service level does not reach the target value, it is decided to modify a value of at least one transmission feature of at least one antenna of one of the communication networks present in the geographical zone, according to one of the embodiment previously described. It can be for example, the antenna gain G_{b} and/or the transmission power Pb of the base stations of the first network R_{T} and/or the bandwidth W. Alternatively, it may also be the gain G_{SAT} of the satellites and/or the power P_{SAT} of the satellites of the second network RSAT. This modification is determined in 34 according to the target value and in order to get closer to this target value.

For example, for a target value D_{u_T} of the useful rate of data reception by the user device UE, the transmission power Pb of the serving base station BS1 is modified into a power Pb′, from the equation (9), as follows:

$${Pb}^{′} = \frac{{G}_{SAT} {P}_{SAT} {K}_{SAT} {F}_{SAT} + {N}_{th}}{{GbKb ( {r}^{2} + {h}^{2} )}^{- \frac{δ}{2}} A ( θ , φ ) \cdot ( a ′ - Fb ( ISD , h , r , θ , φ ) )} \\ with {a}^{′} = \frac{1}{{2}^{\frac{{D}_{u \_ T}}{W}} - 1} , \qquad ( 12 )$$

all other transmission parameters (including those of interfering access devices) being kept constant. In particular, the transmission power Pb of the other interfering base stations of the first network is unchanged.

According to another example, if it is decided to modify the bandwidth W used by the serving base station BS1 so as to reach the target value D_{u_T} of the useful rate of data reception by the user device UE, its new value W′ is determined from the following relation, derived from one of the applicable equations (10) or (10a).

Thus, by way of illustration, in the presence of a second satellite network and a third network of drones, the following is obtained from the equation (10a):

$${W}^{′} = \frac{{Log}_{2} ( 1 + \frac{1}{\begin{matrix}{F}_{b} ( ISD , h , r , θ , φ ) + \\ \frac{{F}_{sat} {G}_{sat} {P}_{sat} {K}_{sat} + {F}_{d} {G}_{d} {P}_{d} {K}_{d}}{{G}_{b} {{KP}_{b} ( {r}^{2} + {h}^{2} )}^{- \frac{δ}{2}} A ( θ , φ )} + \\ \frac{{N}_{th}}{{KP}_{b} {{G}_{b} ( {r}^{2} + {h}^{2} )}^{- \frac{δ}{2}} A ( θ , φ )}\end{matrix}} )}{{D}_{u \_ T}} \qquad ( 13 )$$

all other parameters being kept constant (including those of interfering access devices). In particular, the bandwidth of the other base stations of the first network is unchanged.

A similar procedure could be used for antenna gain.

As a variant, the modified value of the transmission parameter that is considered to be modified is obtained using numerical simulations or experimentally.

In another embodiment, the transmission parameters of the other base stations of the first network and/or the other access devices of the other networks present in the geographical zone are modified. To do this, those skilled in the art can use in particular the relations described previously by replacing the value of the quality-of-service parameter in question by the target value that is aimed for, and by extracting from these relations the value to be given to the transmission parameter that is planned to be modified to reach this target value, or by obtaining the modified value of said transmission parameter by relying on numerical simulations.

In the embodiments of the development just presented, the serving device of the user device UE is a land base station of the first network RT. Of course, the development also applies in the case where the first network is a network of the aerial type and the serving device is a satellite, a drone or a high-altitude platform.

Those skilled in the art will be able to adapt the method for monitoring a quality-of-service level of the development to the specificities of such an aerial access device, by relying on this general knowledge and on the principles and assumptions described previously.

In particular, in the case where the serving device was a satellite, they would obtain:

$${P}_{SAT} = \frac{{G}_{0} {P}_{b} {{K}_{b} ( {r}^{2} + {h}^{2} )}^{- \frac{δ}{2}} A ( θ , φ ) ( 1 + {F}_{b} ) + {N}_{th}}{( {aK}_{SAT} \frac{{G}_{SAT}}{{d}_{SAT}^{2}} - {F}_{SAT} {K}_{SAT} {G}_{SAT} )} \qquad ( 10 b )$$

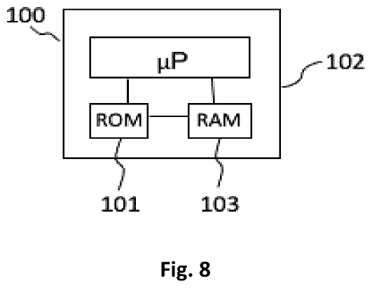

In relation to FIG. 8, an example of the hardware structure of the device 100 for implementing the steps of the method for monitoring a quality-of-service level on the downlink radio link between the base station BS1 and the user device according to the development is now presented.

The device 100 comprises a random access memory 103 (a RAM memory, for example), a processing unit 102 equipped for example with a processor UP and controlled by a computer program stored in a read-only memory 101 (a ROM memory or hard disk, for example). At initialisation, the code instructions of the computer program are for example loaded into a random access memory 103 before being executed by the processor of the processing unit 102.

FIG. 8 only shows a particular one of several possible ways of realising the device 100 so that it carries out the steps of the method for monitoring (according to any one of the embodiments and/or variants described above in relation to FIGS. 3 and 5). Indeed, these steps may be implemented indifferently on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the device 100 is realised with a reprogrammable computing machine, the corresponding program (i.e. the sequence of instructions) can be stored in a removable (such as, for example, a CD-ROM, a DVD-ROM or a USB flash drive) or non-removable storage medium, this storage medium being partially or totally readable by a computer or a processor.

In some embodiments, the device 100 is included in the access device to which the user device UE is attached, for example the serving base station BS1 of the first communication network RT.

In some embodiments, the device 100 is included in a device of the first communication network RT, e.g. in a node of the first communication network R_{T} or in another access device of this first network, for example one of the base stations BS2 or BS3. It can also be integrated in the user device UE or in an access device or node device of another communication network present in the geographical zone and included in the system 10 according to the development, such as the second network RSAT.

1. A method of monitoring a quality-of-service level of a communication between a user device and a first wireless communication network wherein the method comprises:
determining a value of a parameter representative of the quality-of-service level of the communication between an access device referred to as a serving device of the first network to which the user device is attached and the user device, the communication using a given frequency band, the value being determined at least according to a bandwidth allocated to this communication, to transmission features of the serving device, to at least one other access device of the first network and to at least one other access device of at least one second wireless communication network, the other access devices being configured to use the given frequency band and being likely to interfere with the communication, and to a topology of the first network and of the at least one second network in at least one zone referred to as an interference zone; and
when the determined value does not reach a target value of the parameter, obtaining a modification of at least one transmission feature of the serving access device and/or of at least one other access device of the first and/or of the at least one second network, according to the target value.

2. The monitoring method according to claim 1 wherein the parameter value is determined at least according to the bandwidth allocated to the communication, to a distance between the user device and the serving device, to a transmission power of the serving device, to antenna gain ratios between the serving device and the at least one other access device of the first network and between the serving device and the at least one other access device of the at least one second network, and to the topology of the first network and of the at least one second network in the at least one interference zone.

3. Method for The method of monitoring according to claim 1, wherein the first network and the second network are networks of distinct types belonging to a group comprising at least one network of the land type comprising a plurality of land base stations and a network referred to as of the aerial type comprising a plurality of aerial or space access devices and in that determining a value of a parameter representative of the quality of service level of the communication comprises determining a first impact factor of the other access devices of the first network and determining a second impact factor of the access devices of the second network on the value of the parameter.

4. The method according to claim 3, wherein the first network being a network of the land type and the serving device being a land base station-, determining the first impact factor, referred to as a land impact factor, depends on a density of other land base stations of the first network, referred to as interfering base stations, located in a land interference zone defined at least according to an average distance between the base stations of the first network.

5. The method according to claim 4, wherein the first base station comprising a first, a second and a third antenna forming three sectors, determining the land impact factor comprises the implementation of a relation equivalent to the following relation:
$$Fb ( ISD , h , r , θ , φ ) = \frac{{ρ}_{B} {{V}_{1} ( ISD - r )}^{2 - δ} {\int }_{0}^{2 π} {H}_{1} ( θ ) d θ}{( δ - 2 ) {( {r}^{2} + {h}^{2} )}^{- \frac{δ}{2}} A ( θ , φ )} + {\sum }_{2}^{3} \frac{A ( {θ}_{k} , {φ}_{k} )}{A ( θ , φ )} ,$$
where ISD is the average distance between the serving base station and the interfering base stations,
β_{B} is the density of base stations in the land interference zone,
δ is the path-loss factor which models propagation attenuation,
r is the radius or distance between the user device and the first antenna,
h is the height of the first antenna relative to the user device,
(r, θ, φ) is the spherical coordinates of the user device in a coordinate system O1′xyz centred on the serving base station at ground level,
θ is the angle of elevation between the user device and the first antenna,
Φ is the horizontal angle between the user device and the first antenna,
A(θ, φ) is the angular gain of the first antenna of the serving base station, to which the user device UE is connected;
A the angular gain of each of the two other antennas (k=2,3) of the serving base station, co-located with the first antenna of the serving base station, and
H1 is the gain of each antenna of the first network RT, defined as follows by:
H₁ (θ)_{dB}=−min [−H_{dB}, Aₘ+V_{1,dB}], where Aₘ refers to the minimum antenna gain, and
$${V}_{1 , dB} = - min [ 12 {( \frac{{φ}_{tilt}}{{φ}_{3 dB}} )}^{2} , {A}_{m} ] with {H ( θ )}_{dB} = - min [ 12 {( \frac{θ}{{θ}_{3 dB}} )}^{2} , {A}_{m} ]$$
is a constant,
$${V ( φ )}_{dB} = - min [ 12 {( \frac{φ - {φ}_{tilt}}{{φ}_{3 dB}} )}^{2} , {A}_{m} ]$$
where ϕtilt is the downward tilt angle, φ_{3dB} the vertical beamwidth at half-power, θ_{3dB} the horizontal beamwidth at half-power, and
$${\sum }_{2}^{3} \frac{A ( {θ}_{k} , {φ}_{k} )}{A ( θ , φ )} = \frac{( {θ}_{2} , {φ}_{2} ) + ( {θ}_{3} , {φ}_{3} )}{A ( θ , φ )}$$
a contribution from the other two antennas (k=2,3) of the serving base station.

6. The method according to claim 3, wherein the second network being a network of the aerial type comprising a plurality of satellites placed in orbit around the Earth, determining the second impact factor, referred to as satellite impact factor, depends on a density of satellites interfering with the communication in a satellite interference zone defined at least according to an altitude of the satellites of the second network and a minimum angle of elevation of a satellite of the plurality of satellites with the user device.

7. The method according to claim 6, wherein determining a value of a quality-of-service parameter further comprises determining a number of interfering satellites for the communication in the satellite interference zone and in that the density of interfering satellites in the satellite interference zone is determined according to the number of interfering satellites and to an area of a spherical cap centred on the user device, the radius of which being the orbit of the satellites of the satellite network, and bounded by taking the minimum angle of elevation into account.

8. The method according to claim 7, wherein determining the satellite impact factor comprises the implementation of the following equation:
$${F}_{SAT} = {ρ}_{SAT} \frac{π * {( {R}_{T} + {h}_{SAT} )}^{2}}{( {R}_{T} * ( {R}_{T} + {h}_{SAT} ) )} Log \frac{A}{B}$$
where
β_{SAT} is the density of interfering satellites,
Rt: is the radius of the Earth,
hs_{AT} the altitude of the satellite in a coordinate system centred on the user device,
$$A = {( {R}_{T} + {h}_{sSAT} )}^{2} + {R}_{T}^{2} - \frac{2 {R}_{T} ( {R}_{T \cdot } + {h}_{SAT} ) ( {R}_{T \cdot } + {d}_{M} sin ∝ )}{( {R}_{T \cdot } + {h}_{SAT} )} \\ B = {( {R}_{T} + {h}_{sSAT} )}^{2} + {R}_{T}^{2} - 2 {R}_{tT} ( {R}_{T \cdot } + {h}_{SAT} ) ,$$
∝ is the minimum angle of elevation.

9. The method according to claim 3, wherein determining a value of a parameter representative of the quality-of-service level of the communication further comprises determining a transmission power by the serving base station according to the land impact factor and to the at least one second impact factor associated with the at least one second network, implementing a relation equivalent to the following relation:
$${P}_{b} = \frac{{\sum }_{i = 2}^{I} {G}_{i} {P}_{i} {K}_{i} {F}_{i} + {N}_{th}}{{GbKb ( {r}^{2} + {h}^{2} )}^{- \frac{δ}{2}} A ( θ , φ ) . ( a - Fb ( ISD , h , r , θ , φ ) )}$$
where I is an integer greater than or equal to two, referring to a number of the second networks comprising access devices likely to interfere with the communication,
Fb is the land impact factor,
Fᵢ the impact factor of a the second network,
Pᵢ the transmission power of each interfering access device of a the second network,
Gᵢ the gain of each interfering access device of a the second network,
Kᵢ a propagation constant of each interfering access device of a the second network,
G_{b} the gain of the land base stations,
Nₜₕ the thermal noise,
$$a = \frac{1}{{2}^{\frac{{D}_{u}}{W}} - 1}$$
where Dᵤ is the useful rate of data reception by the user device on the downlink radio link, and
W is the bandwidth used by the communication on the downlink radio link between the serving base station and the user device.

10. The method according to claim 1, wherein the quality-of-service parameter belongs to a group comprising at least:
a useful rate of data reception by the user device;
a useful delay of data transmission to the user device; and
a useful power of data reception by from the user device.

11. The method according to claim 9, wherein the quality-of-service parameter belongs to a group comprising at least a useful rate of data reception by the user device, a useful delay of data transmission to the user device, and a useful power of data reception by from the user device;
wherein the quality-of-service parameter comprises a useful rate of data transmission and in that the useful rate is derived from the expression of the transmission power by the first base station and determined according to the following equation:
$${D}_{u} = W {Log}_{2} ( 1 + \frac{1}{\begin{matrix}{F}_{b} ( ISD , h , r , θ , φ ) + \\ \frac{{F}_{sat} {G}_{sat} {P}_{sat} {K}_{sat}}{{G}_{0} {{KP}_{b} ( {r}^{2} + {h}^{2} )}^{- \frac{δ}{2}} A ( θ , φ )} + \\ \frac{{N}_{th}}{{KP}_{b} {{G}_{0} ( {r}^{2} + {h}^{2} )}^{- \frac{δ}{2}} A ( θ , φ )}\end{matrix}} )$$

12. The method according to claim 10, wherein the method comprises determining a third impact factor of a third communication network, of the drone type, according to a density β_{d} of access devices of the drone type, referred to as drones, interfering with the communication in a drone interference zone defined at least according to an altitude of the drones of the third network and to a minimum angle of elevation of a the drone with the user device, and in that the determination implements the following equation:
$${D}_{u} = W {Log}_{2} ( 1 + \frac{1}{\begin{matrix}{F}_{b} ( ISD , h , r , θ , φ ) + \\ \frac{{F}_{sat} {G}_{sat} {P}_{sat} {K}_{sat} + {F}_{D} {G}_{d} {P}_{d} {K}_{d}}{{G}_{0} {{KP}_{b} ( {r}^{2} + {h}^{2} )}^{- \frac{δ}{2}} A ( θ , φ )} + \\ \frac{{N}_{th}}{{KP}_{b} {{G}_{0} ( {r}^{2} + {h}^{2} )}^{- \frac{δ}{2}} A ( θ , φ )}\end{matrix}} )$$
Fd is the impact factor of the drones of the third network on the communication between the serving base station and the user device,
β_{d} is the density of interfering drones,
P_{d} the transmission power of a the interfering drone,
G_{d}: the gain of a the interfering drones, and
K_{d} a propagation constant of the drones.

13. The monitoring method according claim 1, wherein at least one modified transmission feature belongs to a group comprising at least:
a transmission power of the serving access device;
a gain of the serving device;
a transmission bandwidth of the serving device,
a transmission power of at least one other access device,
a gain of at least one other access device; and
a transmission bandwidth of at least one other access device.

14. A device for controlling a quality-of-service level of a communication between a user device and a first wireless communication network, the first network comprising a plurality of access devices configured to transmit radio frequency beams in a given frequency band, said wherein the control device characterised in that it is configured to implement:
determine a value of a parameter representative of the quality-of-service level of the communication between a first access device of the plurality, to which the user device is attached, referred to as a serving access device, at least according to a bandwidth allocated to this communication, to transmission features of the serving access device, to at least one other access device of the first network and to at least one other access device of at least one second wireless communication network, the other access devices being configured to transmit radio frequency beams in the given frequency band and being likely to interfere with the communication, and to a topology of the first network and of the at least one second network in at least one zone referred to as an interference zone; and
when the determined value does not reach a target value of the parameter, determine a modification of at least one transmission feature of at least one antenna of the serving access device and/or one other access device of the plurality and/or at least one second network, according to the target value.

15. The device for controlling according to claim 14, wherein the parameter value is determined at least according to the bandwidth allocated to the communication, to a distance between the user device and the serving device, to a transmission power of the serving device, to antenna gain ratios between the serving device and the at least one other access device of the first network and between the serving device and the at least one other access device of the at least one second network, and to the topology of the first network and of the at least one second network in the at least one interference zone.

16. A communication system, wherein the communication system comprises access devices of a first network and of at least one second network, the access devices being configured to transmit radio frequency beams in a given frequency band, the system further comprising a user device attached to one of the access devices, referred to as a serving access device, and a device for monitoring, according to claim 14, a quality-of-service level of a communication between the serving access device and the user device.
